(19) United States
(12) Patent Application Publication
(10) Pub. No.: US 2019/0018825 A1
(43) Pub. Date: Jan. 17, 2019

(54) AUTOMATIC CLAIM-WRITING DEVICE

(71) Applicant: INTEGRAL SEARCH INTERNATIONAL LIMITED, Taipei City (TW)

(72) Inventor: Hong-Shin TSAI, Taipei City (TW)

(73) Assignee: INTEGRAL SEARCH INTERNATIONAL LIMITED, Taipei City (TW)

(21) Appl. No.: 15/884,975

(22) Filed: Jan. 31, 2018

(30) Foreign Application Priority Data
Jul. 13, 2017 (TW) 106123522

(51) Int. Cl. G06F 17/21; G06F 17/24; G06Q 50/18; G06K 9/00

(52) U.S. Cl. CPC G06F 17/211; G06F 17/24; G06K 9/00469; G06K 9/00463; G06Q 50/184

(57) ABSTRACT

The invention provides an automatic claim-writing device which automatically prompts an organization word block in a claim to be generated or automatically generates an organization word block in the claim to be generated, the automatic claim-writing device comprising: an organization word block type determining module, an interrelationship sub-type determining module, a statistic module and a generating module, the organization word block type determining module determining an organization word block type of existing organization word blocks, the interrelationship sub-type determining module determining an interrelationship sub-type of existing organization word blocks which belongs to the interrelationship type, the generating module automatically prompting or automatically generating the organization word block in a claim to be generated.

### FIELD OF THE INVENTION

The present invention relates to an automatic document-generating device, and more particularly relates to an automatic claim-writing device.

### BACKGROUND OF THE INVENTION

Writing a patent specification is not easy, because a writer should not only know well the technical features, but also should be familiar with the format of patent specification. Moreover the claims in the specification requires the writer to be skilled in the art, since the claims are with special format, habitual way of writing and choice of words.

However, not all the writers can have a good learning environment or a good teacher when learning to write a claim. Generally, at the beginning of learning, they can only learn how to write the patent specification and the claims by themselves. As a result, what a patent writing beginner can learn is usually only partial from subjective observation such that the learning is not systematic and objective. Even if they choose to go learning in an intellectual property law school or meet a very good tutor, the teaching materials given by the intellectual property law school or the tutor will not be scientifically organized. In other words, most of the writing format, habitual way of writing and choice of words appearing in the filed patent application or issued patent might not be taught probably. On the contrary, what patent drafting beginners will be taught will be the tutor's very limited practical result, whereas all kinds of the special format, habitual way of writing and choice of words of the claims are not be able to be taught systematically and objectively.

The inventor of the present invention has discovered that most of the patent specification writers will be more and more limited in the same special format, habitual way of writing and choice of words and thus sometimes the specification and claims writing cannot be precisely expressed. Especially, the development of patent technologies progresses rapidly, if the patent writers can furthermore master special format, habitual way of writing and choice of words which correspond the most to what the majority people use currently, the content of patent specification can be improved spontaneously.

### SUMMARY OF THE INVENTION

Therefore, an objective of the present invention is to provide an automatic claim-writing device which can be used in patent claim teaching, writing and automatically producing such that the learning curve for claim-writing can be reduced and can furthermore master special format, habitual way of writing and choice of words which correspond the most to what the public use currently, thereby improving the content of patent specification.

In order to achieve the above, the present invention provides an automatic claim-writing device which automatically prompts an organization word block in a claim to be generated or automatically generates an organization word block in the claim to be generated, the automatic claim-writing device comprising: an organization word block type determining module which determines an organization word block type of existing organization word blocks, wherein the existing organization word blocks are read from a plurality of existing claims, and the existing organization word block type is one selected from a group comprising a subject element noun type, an interrelationship type and an object element noun type; an interrelationship sub-type determining module which determines an interrelationship sub-type of existing organization word blocks which belongs to the interrelationship type, the existing organization word block being read from a plurality of existing claims; a statistic module which statistically counts the occurrence times of organization word position information which belongs to the existing organization word block occurring in an existing absolute position and/or in an existing relative position, wherein the existing organization word block is read from a plurality of existing claims, and the organization word position information includes the organization word block type, the organization word block corresponding to the organization word block type, the organization word block sub-type and the organization word block corresponding to the organization word block sub-type; and a generating module which automatically prompts the organization word block in a to-be-written absolute position or in a to-be-written relative position of claim to be generated or which automatically generates the organization word block in a to-be-written absolute position or in a to-be-written relative position of claim to be generated.

In one embodiment of the present invention, an automatic claim-writing device provides the generating module automatically prompting the organization word block in the claim to be generated or automatically generating the organization word block in the claim to be generated according to the organization word block type, in the existing absolute position and/or the existing relative position, having higher existing probability regarding the organization word block type, the organization word block corresponding to the organization word block type, the interrelationship sub-type and the organization word block corresponding to the interrelationship sub-type, the existing probability being obtained according to the occurrence times in the existing absolute position and/or the existing relative position.

In one embodiment of the present invention, an automatic claim-writing device provides the generating module automatically prompting the organization word block belonging to a subject element noun type and/or an interrelationship type and/or an object element noun type in the claim to be generated.

In one embodiment of the present invention, an automatic claim-writing device provides the generating module prompting the organization word block on a prompting interface that is provided to be used by a user.

In one embodiment of the present invention, an automatic claim-writing device provides the automatic claim-writing device being further provided with a definition content inputting module that inputs a claim definition content, the claim definition content including a subject element noun belonging to a subject element noun type, an interrelationship belonging to an interrelationship type and an object element noun belonging to an object element noun type.

In one embodiment of the present invention, an automatic claim-writing device provides the generating module automatically prompting the organization word block in the claim to be generated according to the claim definition content to be generated inputted by the definition content inputting module.

In one embodiment of the present invention, an automatic claim-writing device provides the generating module automatically generating the whole organization word block in the claim to be generated according to the claim definition content to be generated inputted by the definition content inputting module.

In one embodiment of the present invention, an automatic claim-writing device provides the definition content inputting module being provided with a definition content inputting interface that receives the claim definition content to be generated.

The automatic claim-writing device of the present invention possesses the technical effects mentioned below. The automatic claim-writing device can be served as a teaching device for claim-writing, offering a scientific analysis concerning the exemplary writing format, high-frequency compositional multiword expressions and choice of words appearing in the filed patent application or issued patent. Moreover, the automatic claim-writing device can be applied to teach, write and automatically generate patent claims. By means of the automatic claim-writing device of the present invention, the learning curve for claim-writing can be reduced and furthermore the content of patent specification can be improved while making the claim-writing easier by mastering the exemplary writing format, high-frequency compositional multiword expressions and choice of words which correspond the most to what the public use currently.

The preferred embodiments of the present invention will become more apparent from the following detailed description of the preferred embodiments relative to the accompanied drawings.

### BRIEF DESCRIPTION OF THE DRAWINGS

FIG. 1 is a block diagram illustrating an automatic claim-writing device according to one embodiment of the present invention.

FIG. 2 is a schematic diagram illustrating a section of word definitions derived from a patent claim in the automatic claim-writing device according to one embodiment of the present invention.

FIG. 3 is a table illustrating an organization word block type of each organization word block in the automatic claim-writing device according to one embodiment of the present invention.

FIG. 4 is a schematic diagram illustrating a plurality of interrelationship sub-types classified according to part-of-speech and meaning of words in each interrelationship in the automatic claim-writing device according to one embodiment of the present invention.

FIG. 5A to FIG. 5E are exemplary diagrams illustrating an organization word block type determining module in the automatic claim-writing device according to one embodiment of the present invention.

FIG. 6A and FIG. 6B are exemplary diagrams illustrating a hierarchical array extension approach used in the automatic claim-writing device according to one embodiment of the present invention.

FIG. 7A to FIG. 7C are exemplary implement diagrams illustrating a generating module of the automatic claim-writing device according to one embodiment of the present invention.

FIG. 8A and FIG. 8B are exemplary implement diagrams illustrating a definition content inputting module of the automatic claim-writing device according to one embodiment of the present invention.

FIG. 9A is a part-of-speech table illustrating element noun grabbing steps of claim re-organizing method according to one embodiment of the present invention.

FIG. 9B is a separating rule table illustrating element noun grabbing steps of claim re-organizing method according to one embodiment of the present invention.

### DETAILED DESCRIPTION OF THE PREFERRED EMBODIMENTS

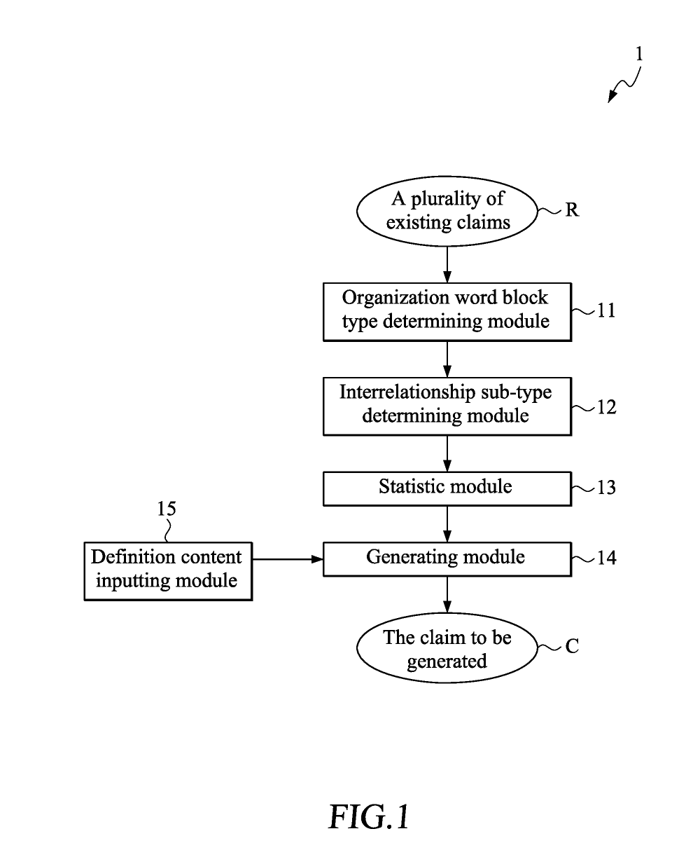

The preferred embodiments of the present invention are described in detail below with reference to drawings from FIG. 1 to FIG. 8B. The description is used for explaining the embodiments of the present invention only, but not for limiting the scope of the claims.

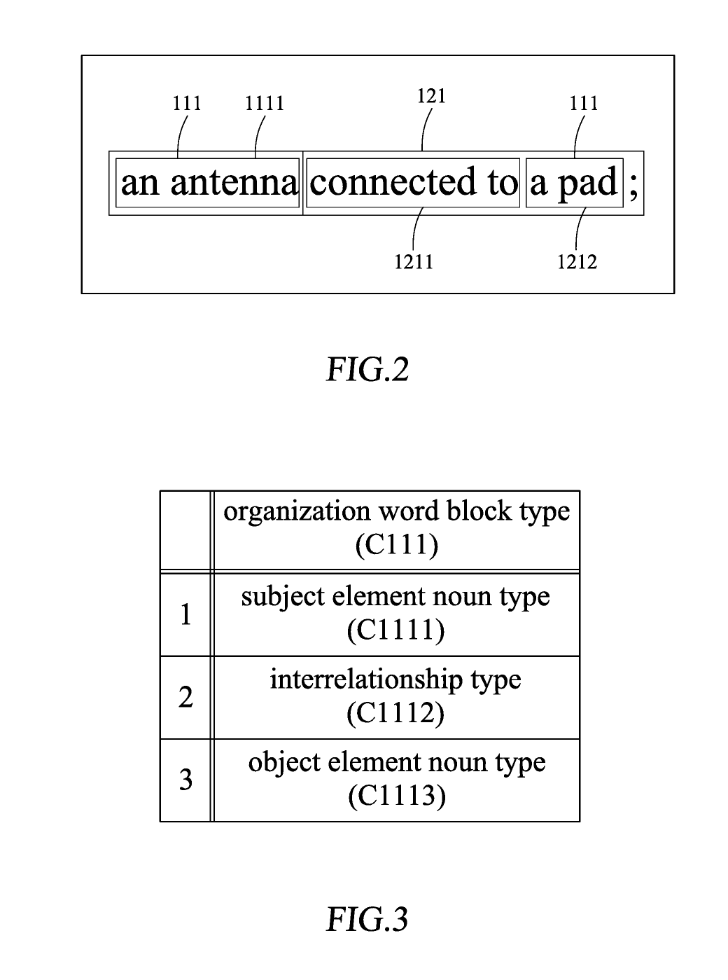

A patent claim is defined by a plurality of word definitions. In FIG. 2, a series of word definitions derived from a patent claim is shown. The series of word definitions is composed in sequence by word definitions of “an”, “antenna”, “connected”, “to”, “a”, “pad”, etc. In the present invention, an element noun 111 is grabbed from the word definitions according to a word part-of-speech rule, and the portion other than the element noun 111 is defined as an interrelationship 1211. In the present invention, each element noun 111 is referred to as one organization word block, and each interrelationship 1211 is also referred to as one organization word block. That is, the word definitions are organized and grabbed as two kinds of different organization word blocks, including an organization word block of element noun and an organization word block of interrelationship. The word definition is a data which is stored in a memory. The data stored in the memory can be read by a processing unit through a data bus connected between the memory and the processing unit in such a manner that the processing unit can perform a grabbing operation according to a word part-of-speech table on the data being read to obtain the word definition. For example, in FIG. 2, the series of word definitions obtained by the grabbing operation of the processing unit is grabbed to obtain element nouns 1111 including “an antenna” and “a pad” and an interrelationship 1211 including “connected to”. Furthermore, each element noun 111 is classified, on the basis of the position in relation to the interrelationship 1211, as: a subject element noun 1111 and an object element noun 1212. After the operation of the processing unit, the element noun of “an antenna” is determined as a subject element noun 1111, and the element noun of “a pad” is determined as an object element noun 1212. That is to say, after the operation of the processing unit, the element noun of “a pad” following the interrelationship 1211 is determined as an object element noun 1212, and the element noun not following the interrelationship 1211 is determined as a subject element noun 1111. Then, the processing unit combines the interrelationship 1211 with the object element noun 1212 to form a complement 121, i.e., “connected to a pad”, and is saved in a memory. The detailed explanation regarding how an element noun 111 including a subject element noun 1111 and an object element noun 1212 according to a word part-of-speech rule can also be found in Taiwan patent No. 1550422. The follows explain one embodiment thereof.

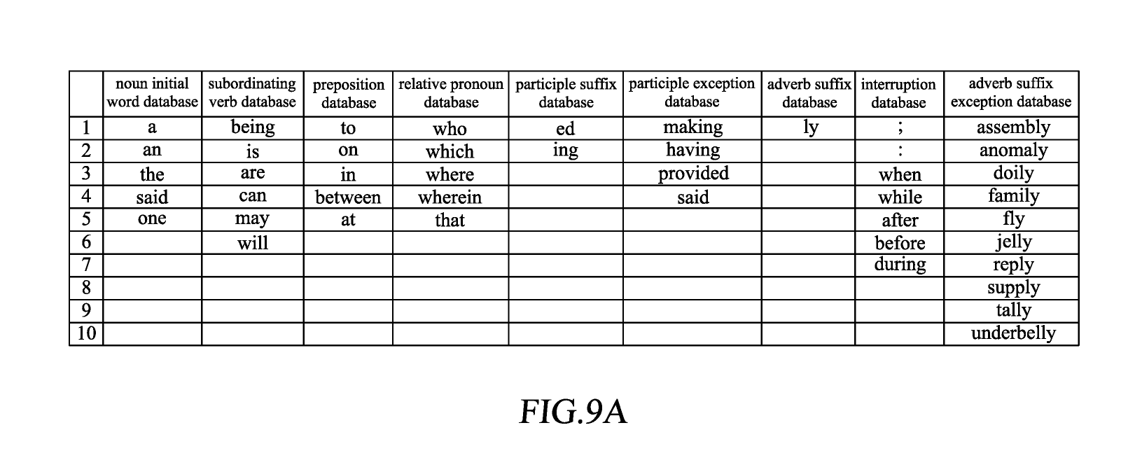

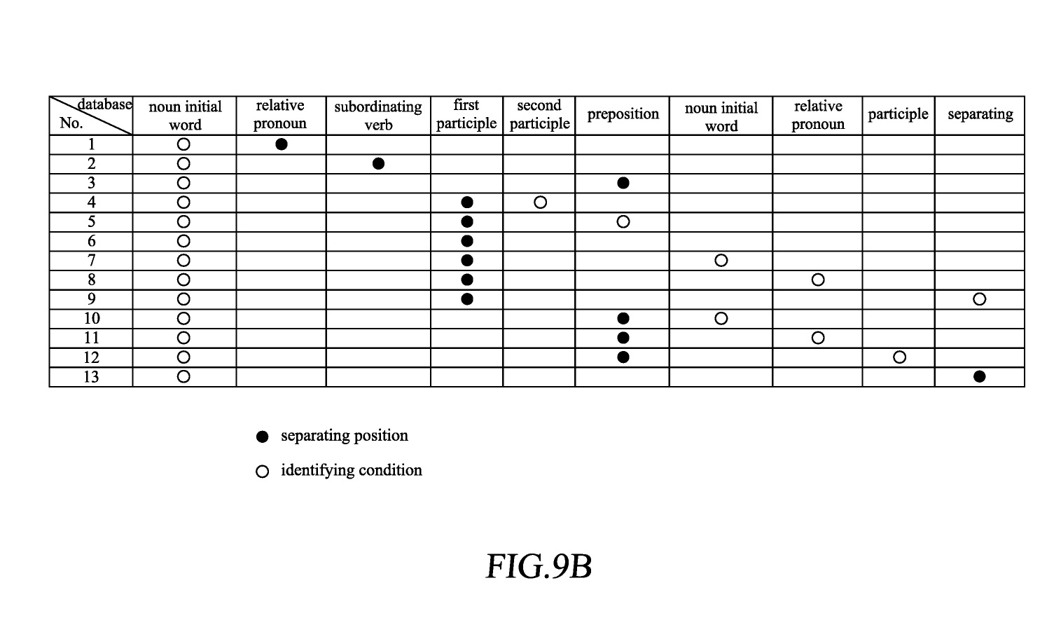

The separating rule table of FIG. 9B is applied together with the part-of-speech table of FIG. 9A to determine a separating position. An example of a sentence in English: “a circuit board provided with edges extending in a longitudinal direction of said circuit board;” is used below to explain the grabbing rules of the present invention by referring to FIG. 9A and FIG. 9B so as to describe how the element noun is grabbed.

When a sentence reading starts from the beginning of the sentence to read [a] as follows: “[a] circuit board provided with edges extending in a longitudinal direction of said circuit board;” where a word bracketed within “[” and “]” is the word being read, the word [a] is recognized as belonging to “noun initial word database” according to part-of-speech table of FIG. 9A. Therefore, the marks of “◯” in the second column of FIG. 9B indicating “noun initial word database” are taken into consideration in the following processes. Then, the sentence reading goes ahead and read [circuit] as follows: “a [circuit] board provided with edges extending in a longitudinal direction of said circuit board;” where “circuit” is recognized as not belonging to any database. Therefore, the sentence reading goes ahead and read [board] as follows: “a circuit [board] provided with edges extending in a longitudinal direction of said circuit board;” where “board” is also recognized as not belonging to any database. The above words including “circuit” and “board” are read and passed, because these words are not with their part-of-speech types found belonging to any part-of-speech database shown in the first row of FIG. 9B, including “relative pronoun database”, “subordinating verb database”, “first participle database”, “second participle database” . . . . Then the sentence reading goes ahead and read [provided] as follows: “a circuit board [provided] with edges extending in a longitudinal direction of said circuit board;” where “provided” is recognized as belonging to a participle database. The fifth column entitled of “first participle” is considered as matching with the read word definition of “provided” such that the next process will be related to one row selected from rows with number from 4 to 9 as indicated by “●” in FIG. 9B. The marks “●” indicates as a temporary separating position. The temporary separating position is a temporary position which will be determined as a separating position when the word following the temporary separating position is determined as a determination word as marked with “◯”. It is noted that the determination word is a word definition that determines the separating position. Then the sentence reading goes ahead and read [with] as follows: “a circuit board provided [with] edges extending in a longitudinal direction of said circuit board;” where “with” is recognized as belonging to a preposition database such that, according to the separating rule table of FIG. 9B, the process with row number 5 is matched and selected since the recognized word “with” is determined as a determination word and the temporary separating word “provided” is then determined as a separating word such that an element noun is determined. Accordingly, the element noun is obtained by grabbing words from the noun initial word to the word neighboring to and before the separating word. In the example, the element noun “a circuit board” is grabbed. The other element nouns are obtained in the same way. After all the element nouns are obtained, the original text is turned into: “[a circuit board] provided with [edges] extending in [a longitudinal direction of said circuit board;]” where the words bracketed within “[” and “]” are the element nouns. Each organization word block between the element nouns are defined as interrelationships including “provided with”, “extending in”. The determination of the element nouns and interrelationships are determined by the processing unit of the present invention. After the element nouns and the interrelationships are obtained, according to the location relationship of the element nouns and the interrelationships, the processing unit classifies the element nouns following the interrelationships as object element nouns 1212, and the element nouns before the interrelationships as subject element nouns 1111.

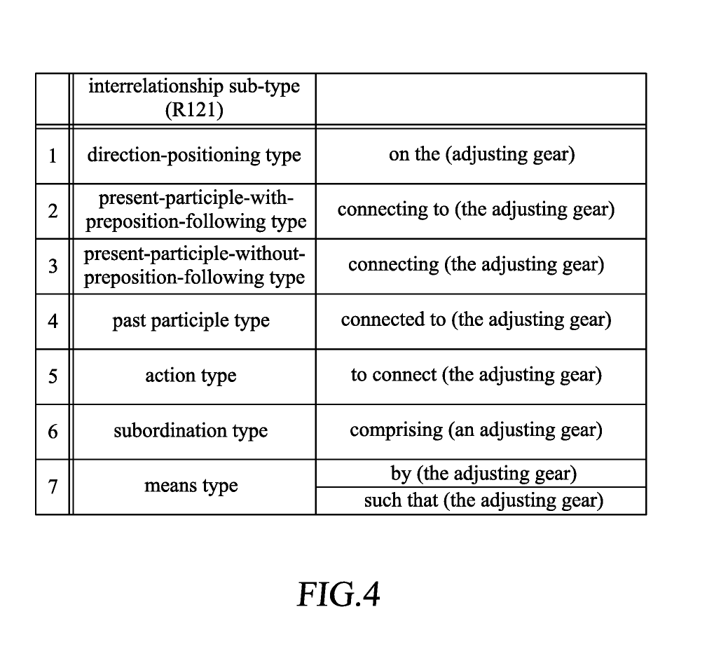

In other words, each organization word block possesses with one of organization word block types, wherein the organization word block type is one selected from a group including a subject element noun type, an interrelationship type and an object element noun type, as shown in FIG. 3. For example, in FIG. 2, the organization word block “an antenna” of the subject element noun is classified as belonging to a subject element noun type, the organization word block of the interrelationship “connected to” belonging to an interrelationship type, and the organization word block of the interrelationship “a pad” belonging to an object element noun type. When the organization word block “connected to” belonging to the interrelationship type is combined with the organization word block “a pad” belonging to the object element noun type, it is found that “connected to a pad” is formed and the formed “connected to a pad” is referred to as a complement.

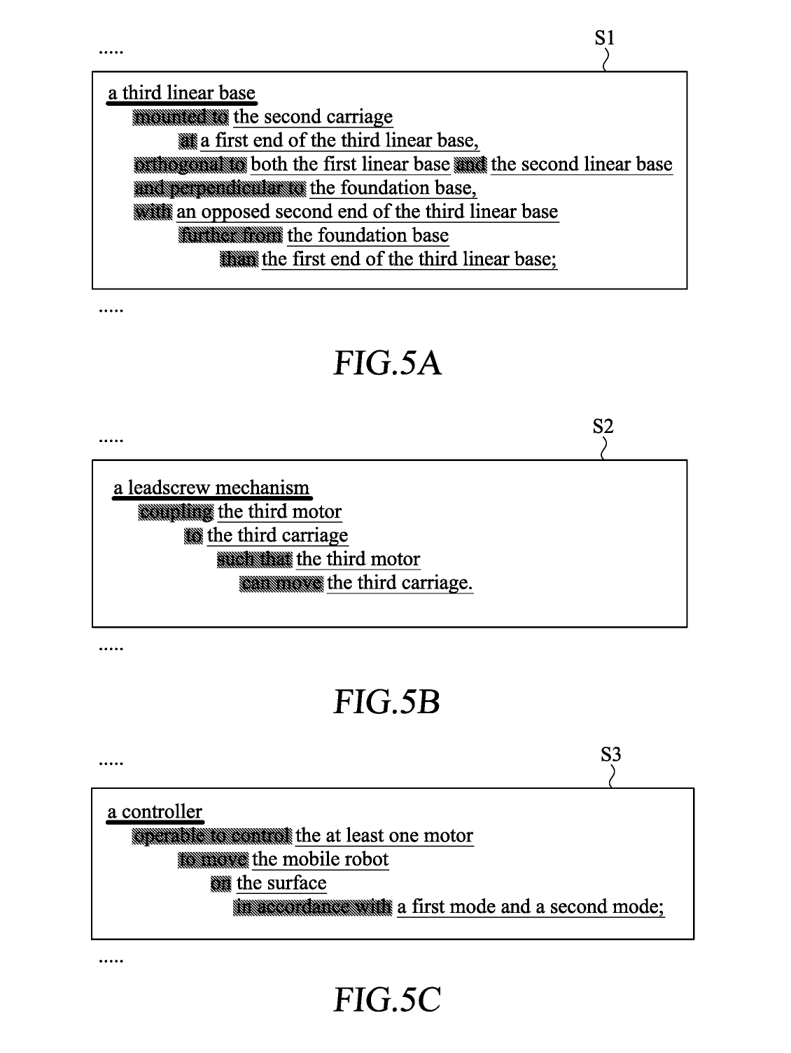

In the present invention, as shown in FIG. 4, according to part-of-speech and meaning of words of the first word definition of the interrelationship, each interrelationship is classified, by the processing unit, as one of a plurality of interrelationship sub-types, wherein the interrelationship sub-type can be one selected from a group including a direction-positioning type, a present-participle-with-preposition-following type, a present-participle-without-preposition-following type, a past participle and adjective type, an action type, a subordination type and a means type. The direction-positioning type is an interrelationship sub-type belonging to an interrelationship possessing an adverb relating to direction or position in the beginning of interrelationship, such as “in”, “on”, “along”, “toward” or “at”, whose examples can be found such as “in (the adjusting gear)”, “on (the housing)”, “along (a parallel direction)”, and “toward (an operating side of the gear)”. The present-participle-with-preposition-following type is an interrelationship sub-type belonging to an interrelationship possessing a present participle, Ving, followed by a preposition, whose example can be found such as “connecting to (the adjusting gear)”. The present-participle-without-preposition-following type is an interrelationship sub-type belonging to an interrelationship possessing a Ving directly followed by an object and not directly followed by a preposition, whose example can be found such as “connecting (the adjusting gear)”. The past participle and adjective type is an interrelationship sub-type belonging to an interrelationship possessing a pass participle, V-ed, or an adjective, whose example can be found such as “connected to (the adjusting gear)”. The action type is an interrelationship sub-type belonging to an interrelationship possessing “to” followed by a verb, whose example can be found such as “to connect (the adjusting gear)”. The subordination type is an interrelationship sub-type belonging to an interrelationship possessing a subordinate verb, such as, “comprising”, “including”, “having” and “with”, whose example can be found such as “comprising (an adjusting gear)”. The means type is an interrelationship sub-type belonging to an interrelationship possessing a means type word, such as “by”, and “via”, whose example can be found such as “by (the adjusting gear)”. The above operation is performed by a processing unit, and the result obtained by the calculation is stored in a memory.

An automatic claim-writing device of one embodiment of the present invention is illustrated as follows. As shown in FIG. 1, an automatic claim-writing device 1 of one embodiment of the present invention is provided with a processing unit by which the automatic claim-writing device 1 automatically prompts an organization word block in a claim C to be generated or automatically generates an organization word block in the claim C to be generated, the automatic claim-writing device comprising: an organization word block type determining module 11 which determines an organization word block type C111 of existing organization word blocks, wherein the existing organization word blocks are read from of a plurality of existing claims R, and the existing organization word block type C111 is one selected from a group comprising a subject element noun type C1111, an interrelationship type C1112 and an object element noun type C1113, as shown in FIG. 3; an interrelationship sub-type determining module 12 which determines an interrelationship sub-type R121 of existing organization word blocks which belongs to the interrelationship type C111, the existing organization word block being read from a plurality of existing claims R; a statistic module 13 which statistically counts the occurrence times of organization word position information which belongs to the existing organization word block occurring in an existing absolute position and/or in an existing relative position, wherein the existing organization word block is read from a plurality of existing claims R, and the organization word position information includes the organization word block type C111, the organization word block corresponding to the organization word block type C111, the interrelationship sub-type R121 and the organization word block corresponding to the interrelationship sub-type R121; and a generating module 14 which automatically prompts the organization word block in a to-be-written absolute position or in a to-be-written relative position of claim C to be generated or which automatically generates the organization word block in a to-be-written absolute position or in a to-be-written relative position of claim C to be generated.

An organization word block is grabbed by the processing unit of the organization word block type determining module 11 and is saved in the memory of the organization word block type determining module 11, but the invention is not limited to this. An organization word block can be grabbed by the central processor of the automatic claim-writing device 1, or can be saved in any one of the memories in the automatic claim-writing device 1 of the present invention.

The determination of the “interrelationship sub-type” is performed by the interrelationship sub-type determining module 12 and the result is saved in the memory of the interrelationship sub-type determining module 12, but the present invention is not limited to this. The determination of the “interrelationship sub-type” can be determined by the central processor of the automatic claim-writing device 1, or the interrelationship sub-type can be saved in any one of the memories in the automatic claim-writing device 1 of the present invention.

The counting result of the statistic module 13 is saved in the memory of the statistic module 13, but the present invention is not limited to this. “The operation that statistically counts the occurrence times of organization word position information which belongs to the existing organization word block occurring in an existing absolute position and/or in an existing relative position, wherein the existing organization word block is read from a plurality of existing claims” can be performed by the central processor of the automatic claim-writing device 1, or the counting result can be saved in any one of the memories in the automatic claim-writing device 1 of the present invention.

The organization word block generating result of the generating module 14 is saved in the memory of the generating module 14, but the present invention is not limited to this. The organization word block generating result of the generating module 14 can be performed by the central processor of the automatic claim-writing device 1, or the organization word block generating result can be saved in any one of the memories in the automatic claim-writing device 1 of the present invention.

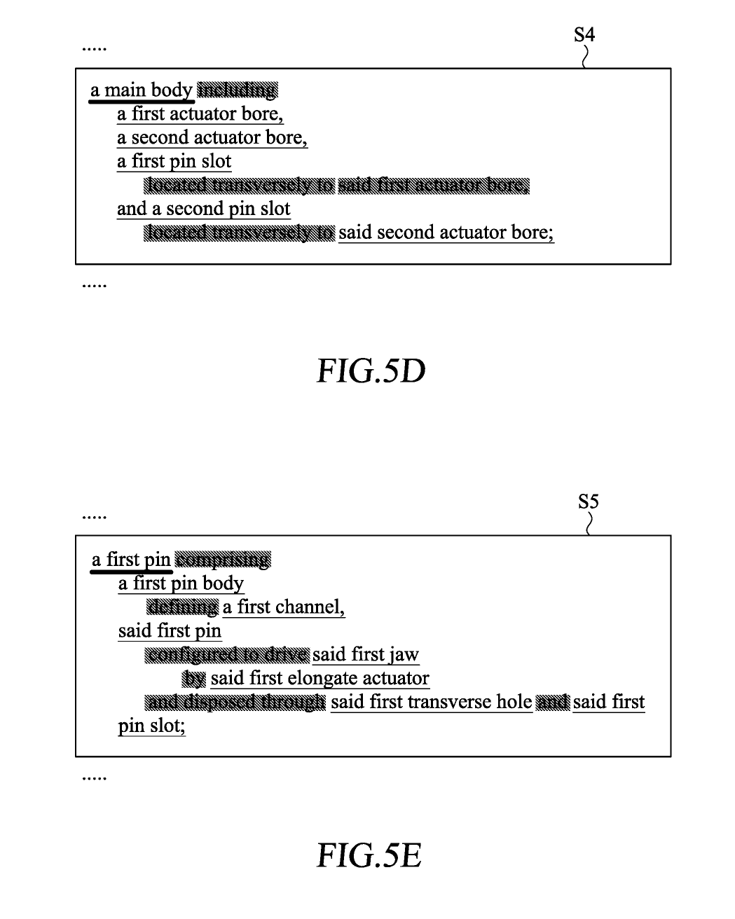

One embodiment of the organization word block type determining module 11 is described below with reference to FIG. 5A to FIG. 5E. The organization word block type determining module 11 reads from a database a plurality of existing claims R, for example, including a section S1 of a claim as shown in FIG. 5A, a section S2 of a claim as shown in FIG. 5B, a section S3 of a claim as shown in FIG. 5C, a section S4 of a claim as shown in FIG. 5D and a section S5 of a claim as shown in FIG. 5E. In FIG. 5A to FIG. 5E, the organization word block with thick underline is an organization word block of the subject element noun type C1111, the organization word block with black background color is an organization word block of the interrelationship type C1112, the organization word block with fine underline is an organization word block of the object element noun type C1113. For example, in FIG. 5A, “a third linear base” is an organization word block of the subject element noun type C1111; “mounted to”, “at”, “orthogonal to”, “and”, “and perpendicular to”, “with”, “further from” and “than” are organization word blocks of the interrelationship type C1112; and “the second carriage”, “a first end of the third linear base”, “both the first linear base and the second linear base”, “the foundation base”, “an opposed second end of the third linear base”, “the foundation base” and “the first end of the third linear base” are organization word blocks of the object element noun type C1113. As mentioned above, the organization word block type determining module 11 of the present invention determines an organization word block type C111 of existing organization word blocks by grabbing all of the element nouns according to a word part-of-speech rule, and defining the portion other than the element noun 111 as an interrelationship, wherein the existing organization word blocks are read from of a plurality of existing claims R. The above operation is performed by a processing unit, and the result obtained by the calculation is stored in a memory.

The present invention further defines an interrelationship sub-type R121 of the interrelationship for the interrelationship type 111 in FIG. 5A to FIG. 5E. The interrelationship sub-type R121 is determined, according to the first word definition of the interrelationship, as one selected from a group including a direction-positioning type, a present-participle-with-preposition-following type, a present-participle-without-preposition-following type, a past participle and adjective type, an action type, a subordination type and a means type. For example, in FIG. 5A, “mounted to” is the past participle type, “at” is the direction-positioning type, “orthogonal to” is the past participle and adjective type, “and perpendicular to” is the past participle and adjective type, “with” is the past participle and adjective type, “further from” is the direction-positioning type, and “than” is the past participle and adjective type. The interrelationship sub-type determining module 12 of the present invention determines an interrelationship sub-type R121 for each interrelationship of the existing organization word blocks. The above operation is performed by a processing unit, and the result obtained by the calculation is stored in a memory.

In addition, when the organization word block type C111 and the interrelationship sub-type R121 of each organization word blocks are determined for each existing claims R, the present invention also records an existing absolute position of the organization word block and/or an existing relative position of the organization word block. One existing relative position is the relative position between/among the existing absolute positions of the individual organization word blocks. In one embodiment, the existing absolute positions and the existing relative positions of the organization word blocks can only be obtained after the organization word blocks of a claim are organized as shown in FIG. 5A to FIG. 5E according to the structural and subordinating meaning of the organization word blocks. The follows explains how an existing relative position of each organization word block are obtained by applying a hierarchical array extension manner. The operation is performed by a processing unit, and the result obtained by the calculation is stored in a memory.

An embodiment of applying the hierarchical array extension manner to obtain an existing absolute position and an existing relative position of the organization word block is illustrated as follows, but the present invention is not limited to this. One having ordinary skill in the art can also obtain the existing absolute position and the existing relative position by another way.

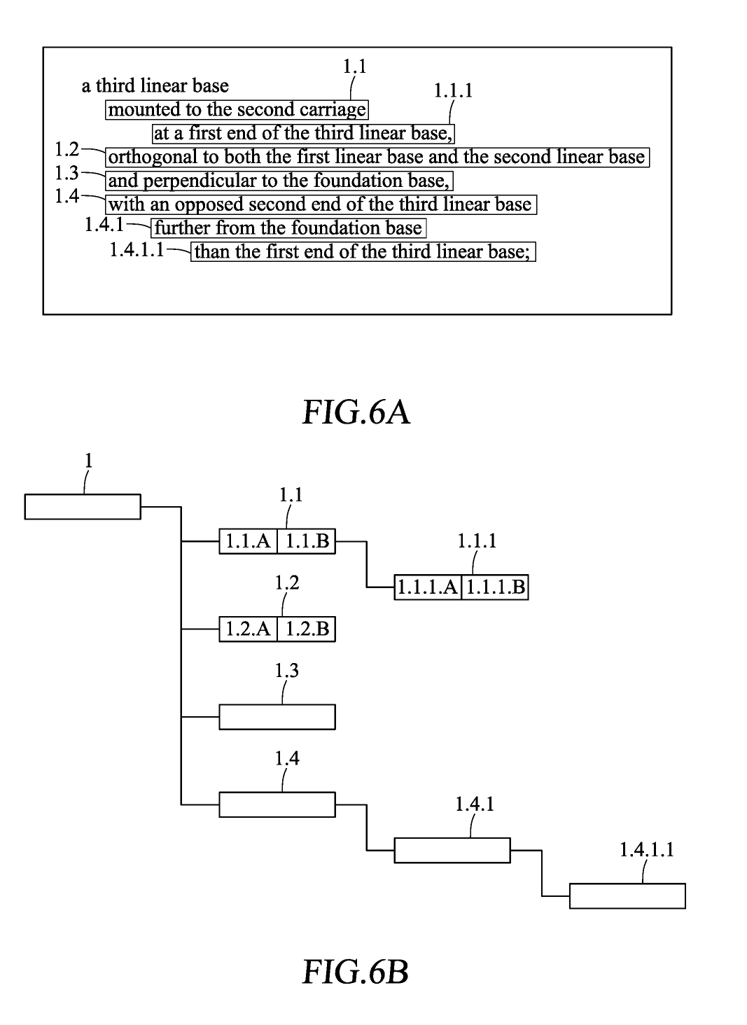

The embodiment of the present invention applies the hierarchical array extension approach. In the hierarchical array extension approach, a dimension amount represents a hierarchical level of an existing absolute position where the organization word block is located as shown in FIG. 6A and FIG. 6B. For example, [1] is a one-dimensional array, representing an organization word block being located in a first level; and [1.1] is a two-dimensional array, representing an organization word block being located in a second level; and [1.1.1] is a three-dimensional array, representing an organization word block being located in a third level. And the organization word block with dimension array of [1.1] is a subordinate organization word block in a level under the organization word block with dimension array of [1], and the organization word block with dimension array of [1.1.1] is a subordinate organization word block in a level under the organization word block with dimension array of [1.1]. And [1.1.A] represents the existing absolute position of interrelationship in the organization word block with dimension array of [1.1]. In addition, [1.1.B] represents the existing absolute position of object element noun in the organization word block with dimension array of [1.1]. Now, a further explanation is made by referring to FIG. 6 as follows:

(A) A subject element noun “a third linear base” is with an existing absolute position represented by [1];

(B) A complement “mounted to the second carriage” which follows the subject element noun is with an existing absolute position represented by [1.1], wherein the interrelationship “mounted to” is with an existing absolute position represented by [1.1.A], and the object element noun “the second carriage” is with an existing absolute position represented by [1.1.B];

(C) A complement “at a first end of the third linear base,” which follows the complement mentioned in (B) is with an existing absolute position represented by [1.1.1], wherein the interrelationship “at” is with an existing absolute position represented by [1.1.1.A], and the object element noun “a first end of the third linear base” is with an existing absolute position represented by [1.1.1.B];

(D) A complement “orthogonal to both the first linear base and the second linear base” which follows the complement mentioned in (C) is with an existing absolute position represented by [1.2], wherein the interrelationship “orthogonal to” is with an existing absolute position represented by [1.2.A], and the object element noun “both the first linear base and the second linear base” is with an existing absolute position represented by [1.2.B];

(E) A complement “and perpendicular to the foundation base,” which follows the complement mentioned in (D) is with an existing absolute position represented by [1.3], wherein the interrelationship “and perpendicular to” is with an existing absolute position represented by [1.3.A], and the object element noun “the foundation base” is with an existing absolute position represented by [1.3.B];

(F) A complement “with an opposed second end of the third linear base” which follows the complement mentioned in (E) is with an existing absolute position represented by [1.4], wherein the interrelationship “with” is with an existing absolute position represented by [1.4.A], and the object element noun “an opposed second end of the third linear base” is with an existing absolute position represented by [1.4.B];

(G) A complement “further from the foundation base” which follows the complement mentioned in (F) is with an existing absolute position represented by [1.4.1], wherein the interrelationship “further from” is with an existing absolute position represented by [1.4.1.A], and the object element noun “the foundation base” is with an existing absolute position represented by [1.4.1.B]; and

(H) A complement “than the first end of the third linear base” which follows the complement mentioned in (G) is with an existing absolute position represented by [1.4.1.1], wherein the interrelationship “than” is with an existing absolute position represented by [1.4.1.1.A], and the object element noun “the first end of the third linear base” is with an existing absolute position represented by [1.4.1.1.B].

The above operation is performed by a processing unit, and the result obtained by the calculation is stored in a memory.

As mentioned above, after the existing absolute position of each organization word block is obtained, an existing relative position in relation to other organization word block can be obtained. For example, in consideration of the subject element noun “a third linear base” having an existing absolute position represented by [1], and the complement “mounted to the second carriage” following the subject element noun and having an existing absolute position represented by [1.1], it can be found that both of the two organization word blocks have the same first dimension value of “1”, and the complement “mounted to the second carriage” has an extra second dimension with value of “1”. Therefore the complement “mounted to the second carriage” having the existing absolute position represented by [1.1] can be determined as “a complement located at the next level of the organization word block, i.e., a third linear base” and “the complement being the first element in said next level”.

In consideration of the complement “mounted to the second carriage” having an existing absolute position represented by [1.1], and the complement “at a first end of the third linear base” following the complement “mounted to the second carriage” and having an existing absolute position represented by [1.1.1], it can be found that both of the two organization word blocks have the same first dimension value of “1” and the same second dimension with value of “1”, but the complement “at a first end of the third linear base” has the third dimension value of “1”. Therefore the complement “at a first end of the third linear base” having the existing absolute position represented by [1.1.1] can be determined as “a complement located at the next level of the organization word block, i.e., mounted to the second carriage” and “the complement being the first element in said next level”.

In consideration of the complement “at a first end of the third linear base,” having an existing absolute position represented by [1.1.1], and the complement “orthogonal to both the first linear base and the second linear base” following the complement “at a first end of the third linear base,” and having an existing absolute position represented by [1.2], it can be found that the differences between the two organization word blocks are in the second dimension value and in the third dimension value as well. Therefore the complement “orthogonal to both the first linear base and the second linear base” having an existing absolute position represented by [1.2] can be determined as “a complement located at the previous level of the organization word block, i.e., at a first end of the third linear base” and “the complement being the second complement of the subject element noun, i.e., a third linear base, which has an existing absolute position represented by [1]”.

In consideration of the complement “orthogonal to both the first linear base and the second linear base” having an existing absolute position represented by [1.2], and the complement “and perpendicular to the foundation base” following the complement “orthogonal to both the first linear base and the second linear base” and having an existing absolute position represented by [1.3], it can be found that the difference between the two organization word blocks is in the second dimension value. Therefore the complement “and perpendicular to the foundation base” having an existing absolute position represented by [1.3] can be determined as “a complement located at the same level as the organization word block, i.e., orthogonal to both the first linear base and the second linear base” and “both complements being positioned in sequence in the same level” and “both complements being located at the next level of the subject element noun, i.e., a third linear base, having an existing absolute position represented by [1]”.

In consideration of the complement “and perpendicular to the foundation base” having an existing absolute position represented by [1.3], and the complement “with an opposed second end of the third linear base” following the complement “and perpendicular to the foundation base” and having an existing absolute position represented by [1.4], it can be found that the difference between the two organization word blocks is in the second dimension value. Therefore the complement “with an opposed second end of the third linear base” having an existing absolute position represented by [1.4] can be determined as “a complement located at the same level as the organization word block, i.e., and perpendicular to the foundation base” and “both complements are positioned in sequence in the same level” and “both complements being located at the next level of the subject element noun, i.e., a third linear base, which has an existing absolute position represented by [1]”.

In consideration of the complement “with an opposed second end of the third linear base” having an existing absolute position represented by [1.4], and the complement “further from the foundation base” following the complement “with an opposed second end of the third linear base” and having an existing absolute position represented by [1.4.1], it can be found that the difference between the two organization word blocks is in the third dimension value. Therefore the complement “further from the foundation base” having an existing absolute position represented by [1.4.1] can be determined as “a complement located at the next level of the organization word block, i.e., with an opposed second end of the third linear base” and “the complement being the first element in the said next level”.

In consideration of the complement “further from the foundation base” having an existing absolute position represented by [1.4.1], and the complement “than the first end of the third linear base” following the complement “with an opposed second end of the third linear base” and having an existing absolute position represented by [1.4.1.1], it can be found that the difference between the two organization word blocks is in the fourth dimension value. Therefore the complement “than the first end of the third linear base” having an existing absolute position represented by [1.4.1.1] can be determined as “a complement located at the next level of the organization word block, i.e., further from the foundation base” and “the complement being the first one element in said next level”. The above operation is performed by a processing unit, and the result obtained by the calculation is stored in a memory.

Accordingly, the same method can be applied to obtain the existing absolute positions and the existing relative positions for all of the organization word blocks in FIGS. 5B to 5E. As a result, all details in each one of the existing absolute position and/or existing relative position in the read existing claims R, including the organization word block type C111, the organization word block corresponding to the organization word block type C111, the interrelationship sub-type R121, can be obtained. In addition, the organization word blocks corresponding to each interrelationship sub-type R121 can also be obtained.

In other embodiments of the present invention, on the contrary, the existing relative positions can be firstly obtained before that the existing absolute positions are obtained. Furthermore, the existing relative positions can be directly obtained, without performing the structural organization for all organization word blocks in a claim as shown in FIGS. 5A to 5E, by applying the organization word block types C111 of the organization word blocks, and thereafter the existing absolute positions are obtained by the existing relative positions. The above operation is performed by a processing unit, and the result obtained by the calculation is stored in a memory.

The above-mentioned “the organization word blocks corresponding to each interrelationship sub-type R121 can also be obtained” is achieved by enabling a statistic module 13 to perform a statistic and recording operation for the organization word blocks obtained as the interrelationship in the complement. For example, in FIG. 5A, the occurrence times of “mount to”, “at”, “orthogonal to”, “perpendicular to”, “with”, “further from” and “than” are statistically counted and recorded. The detail of the statistic module 13 is described as follows.

The statistic module 13 of the present invention performs a statistical counting and recording operation that obtains a statistic result regarding organization word position information in all existing absolute positions and/or in existing relative positions from all of the read plurality of existing claims R, the organization word position information including the organization word block types C111, the organization word blocks corresponding to each organization word block type C111, the interrelationship sub-types R121 and the organization word blocks corresponding to each interrelationship sub-type R121. As a result, a data distribution is obtained for every organization word position information located in all existing absolute positions and/or in all existing relative positions, such as the organization word block types C111, the organization word blocks corresponding to each organization word block type C111, the interrelationship sub-types R121 and the organization word blocks corresponding to each interrelationship sub-type R121.

After the data distribution in all existing absolute positions and/or in all existing relative positions is obtained, the present invention is provided with a generating module that automatically prompts the organization word blocks in a to-be-written absolute position or in a to-be-written relative position of claim to be generated C to a user by displaying these organization word blocks on the displaying screen for a user to choose one of them, or automatically generates the organization word block in a to-be-written absolute position or in a to-be-written relative position of claim to be generated C.

The below explains how the organization word blocks are automatically prompted in a to-be-written absolute position or in a to-be-written relative position of claim to be generated C for a user to choose, and how the organization word block is automatically generated in a to-be-written absolute position or in a to-be-written relative position of claim to be generated C, in one embodiment of the present invention, but is not limited to this. In the to-be-written absolute position or in a to-be-written relative position of claim to be generated C, the generating module 14 automatically prompts or generates the valuable organization word blocks including: the organization word blocks having higher occurrence corresponding to one organization word block type belonging to the specific to-be-written absolute position or in a to-be-written relative position; the interrelationship sub-types with higher occurrence; and the organization word blocks with higher existing occurrence corresponding to the interrelationship sub-types belonging to the specific to-be-written absolute position or in a to-be-written relative position, while these information is obtained by the statistic module 13. But the present invention is not limited to this, the organization word blocks can also be provided in a random way by retrieving the organization word blocks from the existing data distribution.

For example, after considering the organization word blocks including organization word blocks with higher occurrence corresponding to one organization word block type belonging to the specific to-be-written absolute position or in a to-be-written relative position, the interrelationship sub-types with higher occurrence and the organization word blocks with higher existing occurrence corresponding to the interrelationship sub-types belonging to the specific to-be-written absolute position or in a to-be-written relative position, the present invention determines that, in the to-be-written absolute position from [1.1] to [1.1.1], the interrelationship complement is with higher occurrence, wherein the present participle or past participle is with higher occurrence in the interrelationship complement, and the past participle is with higher occurrence than that of the present participle such that the past participles “connected to”, “configured to connect”, “located to” and “disposed to” are determined as the organization word blocks to be prompted in sequence or determines the past participles “connected to”, “configured to connect”, “located to” and “disposed to” as the organization word blocks to be generated in the to-be-written absolute position or in the to-be-written relative position. In another example, after considering the organization word blocks including organization word blocks with higher occurrence corresponding to one organization word block type belonging to the specific to-be-written absolute position or in a to-be-written relative position, the interrelationship sub-types with higher occurrence and the organization word blocks with higher existing occurrence corresponding to the interrelationship sub-types belonging to the specific to-be-written absolute position or in a to-be-written relative position, the present invention determines that, in the to-be-written absolute position of [1.1.1.1], the interrelationship complement is with higher occurrence, and the means type interrelationship complement is with higher occurrence in the interrelationship complement such that the means type organization word blocks “such that”, “in such a manner that”, “by” are determined as the organization word blocks to be prompted in sequence or determines the means type organization word blocks “such that”, “in such a manner that”, “by” as the organization word blocks to be generated in the to-be-written absolute position or in the to-be-written relative position.

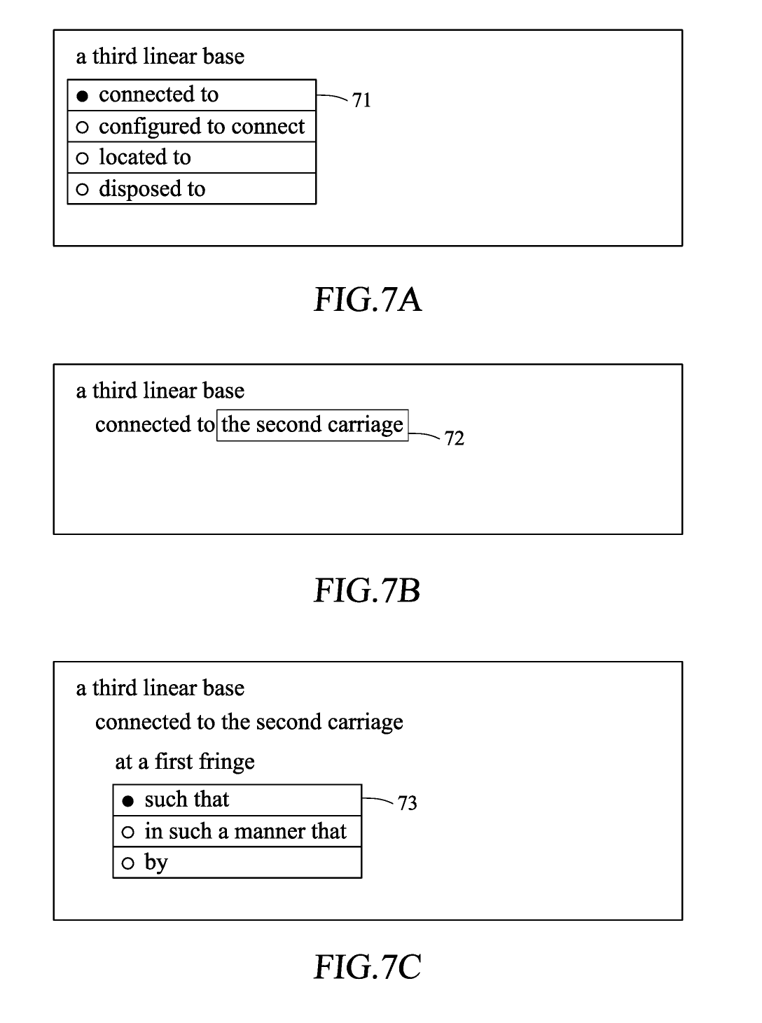

As shown in FIG. 7A to FIG. 7C, an automatic claim-writing device according to one embodiment of the present invention is provided with the generating module 14 that automatically respectively prompts the organization word blocks corresponding to the subject element noun type, the interrelationship type and the object element noun type in the claim to be generated. In FIG. 7A, a prompting interface 71 is provided to prompt the organization word blocks of past participle interrelationship which is with higher occurrence in the to-be-written absolute position [1.1] such that “connected to”, “configured to connect”, “located to” and “disposed to” are prompted in sequence for a user to choose. In this example, the user clicks “o” to choose the organization word block “connected to”, and then as shown in FIG. 7B, an input field of object element noun 72 appears for the user to input an object element noun. In FIG. 7C, the present invention determines that the means type interrelationship is with higher occurrence in the to-be-written absolute position [1.1.1.1], and accordingly “such that”, “in such a manner that” and “by” are prompted in sequence for the user to click “◯” on a prompting interface 73 to choose. The above prompting and displaying operation is performed by a processing unit, and the result obtained by the operation is stored in a memory.

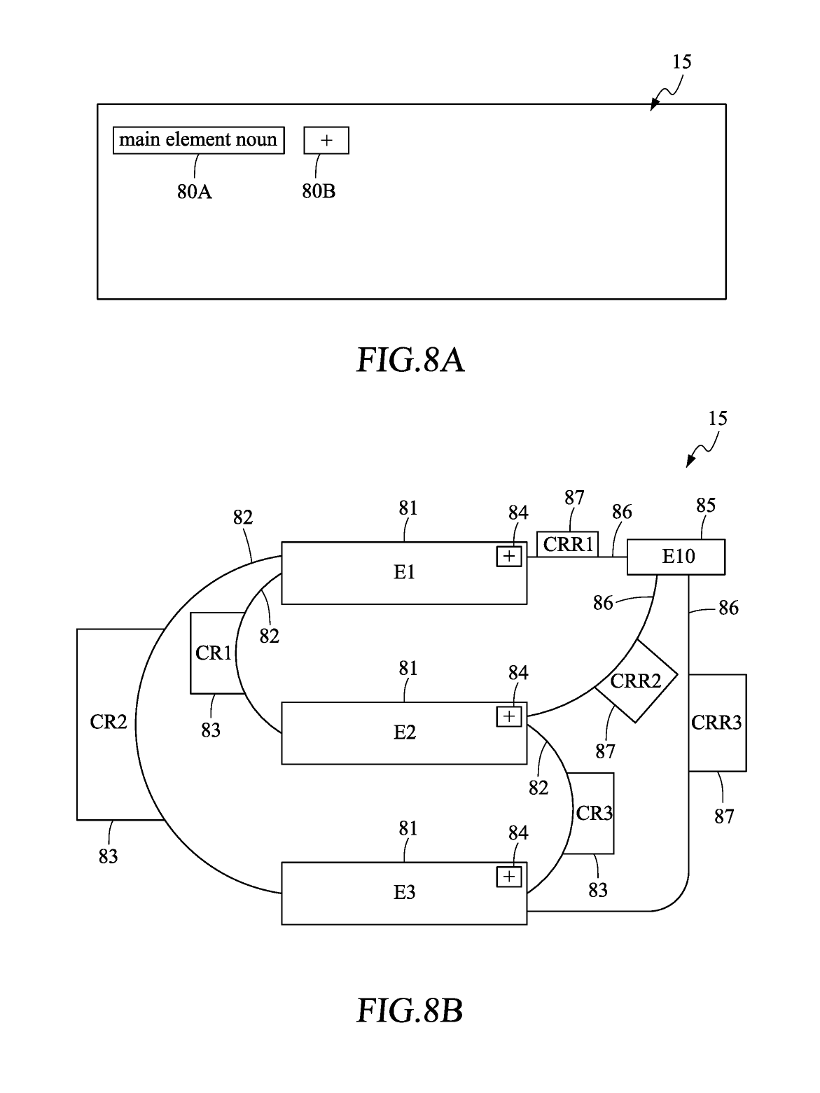

The automatic claim-writing device 1 according to one embodiment of the present invention is further provided with a definition content inputting module 15 that provides an interface to allow a user to input claim definition contents to be generated, any one of the claim definition content to be generated can be one claim definition content to be generated selected from a group comprising a subject element noun 1111 with the subject element noun type, an interrelationship 1211 with the interrelationship type, an object element noun 1212 with the object element noun type. In FIG. 8A, a displaying interface of the definition content inputting module 15 is shown. A main element noun inputting field 80A is provided to which a user can input a main element noun which refers to a noun of main element to form a claim. The main element noun can be either the subject element noun or the object element noun. A main element noun adding button 80B is provided to locate on the right side of the main element noun inputting field 80A for adding some other main element nouns such that one or a plurality of main element noun can be obtained by repeatedly operating the main element noun adding button 80B. FIG. 8B shows an exemplary situation in which a user adds two more main element nouns to show three main element nouns E1, E2 and E3. Each one of the three main element nouns E1, E2 and E3 are displayed in a main element displaying field 81 respectively. Moreover, when a plurality of the main element displaying fields 81 are displayed, an interrelationship connecting line 82 between each two main element displaying fields 81 is displayed. Furthermore, an interrelationship inputting field 83 corresponding to each interrelationship connecting line 82 is also displayed such that a user can input the interrelationship definitions CR1, CR2 and CR3 in the interrelationship inputting field 83. In addition, each main element displaying fields 81 is further provided with a corresponding element noun adding button 84 such that a user can operate the corresponding element noun adding button 84 to add a corresponding element noun by generating a corresponding element noun field 85. The corresponding element noun is defined as a noun which structurally belongs to the main element noun defined in the main element displaying field 81. After the corresponding element noun is displayed in the corresponding element noun field 85, an corresponding interrelationship connecting line 86 connecting between the corresponding element noun field 85 and each main element displaying field 81 is displayed. In addition a corresponding interrelationship inputting field 87 corresponding to each corresponding interrelationship connecting line 86 is displayed such that a user can input the interrelationship definitions CRR1, CRR2 and CRR3 in the corresponding interrelationship inputting field 87. It is noted that all corresponding element noun fields 85 can further provided with an element noun adding button, not shown in the figure, so as to add other element nouns which corresponds to the corresponding element noun fields 85.

By means of the interface shown in FIG. 8A and FIG. 8B, the generating module 14 can receive the claim definition content to be generated therefrom so as achieve the function that all organization word blocks can be automatically generated to form a claim to be generated. The above operation is performed by a processing unit, and the result obtained by the calculation is stored in a memory.

The above description should be considered only as an explanation of the preferred embodiment of the present invention. A person with ordinary skill in the art can make various modifications to the present invention based on the scope of the claims and the above description. However, those modifications shall fall within the scope of the present invention.

What is claimed is:

1. An automatic claim-writing device which automatically prompts an organization word block in a claim to be generated or automatically generates an organization word block in the claim to be generated, the automatic claim-writing device comprising:
an organization word block type determining module which determines an organization word block type of existing organization word blocks according to part-of-speech of words belonging to the existing organization word blocks, wherein the existing organization word blocks are read from a plurality of existing claims, and the existing organization word block type is one selected from a group comprising a subject element noun type, an interrelationship type and an object element noun type;
an interrelationship sub-type determining module which determines an interrelationship sub-type of existing organization word blocks which belongs to the interrelationship type, the existing organization word block being read from a plurality of existing claims;
a statistic module which statistically counts the occurrence times of organization word position information which belongs to the existing organization word block occurring in an existing absolute position and/or in an existing relative position, wherein the existing organization word block is read from a plurality of existing claims, and the organization word position information includes the organization word block type, the organization word block corresponding to the organization word block type, the organization word block sub-type and the organization word block corresponding to the organization word block sub-type; and
a generating module which automatically prompts the organization word block in a to-be-written absolute position or in a to-be-written relative position of claim to be generated or which automatically generates the organization word block in a to-be-written absolute position or in a to-be-written relative position of claim to be generated.

2. The automatic claim-writing device of claim 1, wherein the generating module automatically prompts the organization word block in the claim to be generated or automatically generates the organization word block in the claim to be generated according to the organization word block type, in the existing absolute position and/or the existing relative position, having higher existing probability regarding the organization word block type, the organization word block corresponding to the organization word block type, the interrelationship sub-type and the organization word block corresponding to the interrelationship sub-type, the existing probability being obtained according to the occurrence times in the existing absolute position and/or the existing relative position.

3. The automatic claim-writing device of claim 1, wherein the generating module automatically prompts the organization word block belonging to a subject element noun type and/or an interrelationship type and/or an object element noun type in the claim to be generated.

4. The automatic claim-writing device of claim 1, wherein the generating module prompts the organization word block on a prompting interface that is provided to be used by a user.

5. The automatic claim-writing device of claim 1, wherein the automatic claim-writing device is further provided with a definition content inputting module that inputs a claim definition content, the claim definition content including a subject element noun belonging to a subject element noun type, an interrelationship belonging to an interrelationship type and an object element noun belonging to an object element noun type.

6. The automatic claim-writing device of claim 5, wherein the generating module automatically prompts the organization word block in the claim to be generated according to the claim definition content to be generated inputted by the definition content inputting module.

7. The automatic claim-writing device of claim 5, wherein the generating module automatically generates the whole organization word block in the claim to be generated according to the claim definition content to be generated inputted by the definition content inputting module.

8. The automatic claim-writing device of claim 5, wherein the definition content inputting module is provided with a definition content inputting interface that receives the claim definition content to be generated.
